(19) United States
(12) Patent Application Publication
(10) Pub. No.: US 2007/0068991 A1
(43) Pub. Date: Mar. 29, 2007

(54) Ultrasonic welding system

(76) Inventors: Jeffrey M. Handel, Canfield, OH (US); Matthew A. Clark, Bristolville, OH (US)

Correspondence Address: DELPHI TECHNOLOGIES, INC., M/C 480-410-202, PO BOX 5052, TROY, MI, 48007, US

(21) Appl. No.: 11/233,753

(22) Filed: Sep. 23, 2005

(51) Int. Cl. B23K 37/00; B23K 5/20

(52) U.S. Cl. 228/1.1

(57) ABSTRACT

The present invention is an ultrasonic welding system having an ultrasonic welder integrated with a servo press for galling and ultrasonic welding of a first workpiece to a second workpiece. The first and second workpieces are substantially disposed between a confronting tip and stationary anvil of the ultrasonic welder. Prior to welding, the servo press preferably quickly moves the tip toward and generally against the first workpiece. During welding, a variable speed motor of the servo press preferably slowly moves the tip toward the anvil compressing the workpieces together while a transducer of the ultrasonic welder transmits mechanical vibration to the tip for welding the workpieces together.

### TECHNICAL FIELD

The present invention relates to an ultrasonic welding system and more particularly to an ultrasonic welding system utilizing a servo press.

### BACKGROUND OF THE INVENTION

Ultrasonic welding systems which attach like-material workpieces together are generally known, as exemplified in U.S. Pat. No. 6,588,646, issued Jul. 8, 2003 and incorporated herein in it's entirety. Ultrasonic welders utilize ultrasonic energy to join, for instance, plastic to plastic or nonferrous metal to nonferrous metal. Ultrasonic welding is not actually “welding” in the sense that there is no application of heat as is used in conventional welding, wherein metals are heated to the point of melting into each other. In the case of ultrasonic welding, the like-material workpieces are placed between a movable tip and a stationary anvil of the welder. A mechanical vibration is transmitted to the tip that is then applied to the workpieces.

The frequency and the amplitude of the vibration cause the generally like-material workpieces to mutually gall at their contact surfaces. This galling results in contaminants, such as for example surface oxidation, to be displaced. The galling further causes the contact surfaces to be polished. As galling continues, the contact surfaces become intimate, whereupon atomic and molecular bonding occurs therebetween, thereby bonding the like-materials together with a weld-like efficacy (ergo, the term “ultrasonic welding”).

A number of considerations determine the efficacy of the workpiece-to-workpiece surface bond, the major considerations being the amplitude of the vibration at the tip, the applied force at the tip and the time of the actual welding application. Typically, these variables are predetermined to achieve the most efficacious bond based upon the materials and the particular application. The accuracy of the weld time and applied force is generally dependent upon the ability to control tip movement. Known ultrasonic welders utilize pneumatic air cylinders to move the tip toward and away from the workpieces. Unfortunately, air cylinder speed does not change during the welding cycle. A compromise must be made to find the speed to approach the weld area as fast as possible without damaging the weld area from the tip impact. Moreover, known systems are depended on timing to approximate the time the air cylinder impacted the workpieces to be welded and thereby initiating a weld cycle. This approximation also leads to inconsistencies in welding. An approximation too early can produce an under-welded part. An approximation too late can produce a stall effect of known ultrasonic horns of the welder. The smaller the workpieces (i.e. stranded electrical wire of twenty gage or greater), the greater is the negative effects of these variables upon the quality of the completed weld.

### SUMMARY OF THE INVENTION

The present invention is an ultrasonic welding system having an ultrasonic welder integrated with a servo press for galling and ultrasonic welding of a first workpiece to a second workpiece. The first and second workpieces are substantially disposed between a confronting tip and stationary anvil of the ultrasonic welder. Prior to welding, the servo press preferably quickly moves the tip toward and generally against the first workpiece. During welding, a variable speed motor of the servo press preferably slowly moves the tip toward the anvil compressing the workpieces together while a transducer of the ultrasonic welder transmits mechanical vibration to the tip for welding the workpieces together.

Preferably, prior to welding a programmable logic controller outputs an initiation and high speed signal to a motion controller of the ultrasonic welder. The motion controller then sends a torque limiting signal to a servo motor of the press for operating the motor and quickly staging the tip against the first workpiece. Position sensors of the press send signals to the motion controller for indication of tip placement. The position of the tip is inputted into the logic controller. When the tip is properly staged, the logic controller sends a weld initiation signal to a weld controller of the ultrasonic controller which sends a weld force analog signal to the motion controller. Simultaneously, the logic controller sends a slow speed signal to the motion controller for slow compression of the workpieces during welding.

Advantages of the present invention include a highly versatile ultrasonic welding system capable of approaching a weld article within millimeters at high acceleration and speed without contacting the article. Once within a small distance, the servo motor can contact the weld article with little impact and initiate welding at more precise timing. Other advantages include a more robust system that increases quality control with improved and more consistent ultrasonic welds.

### BRIEF DESCRIPTION OF THE DRAWINGS

The presently preferred embodiments of the invention are disclosed in the following description and in the accompanied drawings, wherein:

FIG. 1 is a side view of an ultrasonic welding system of the present invention;

FIG. 2 is a front view of the ultrasonic welding system;

FIG. 3 is a top view of the ultrasonic welding system;

FIG. 4 is a cross section of the ultrasonic welding system taken along line 4-4 of FIG. 3;

FIG. 5 is a block diagram of the ultrasonic welding process;

FIG. 6 is a front view of a logic controller of the ultrasonic welding system;

FIG. 7 is a front view of a tip prop of the ultrasonic welding system;

FIG. 8 is a side view of the tip prop of the ultrasonic welding system;

FIG. 9 is a top view of an anvil of the ultrasonic welding system;

FIG. 10 is a front view of an anvil prop of the ultrasonic welding system;

FIG. 11 is a side view of the anvil prop;

FIG. 12 is an exploded perspective view of a first and second workpiece to be galled together by the ultrasonic welding system;

FIG. 13 is an enlarged lateral cross section of a tip, and the anvil of the ultrasonic welding system bearing down upon two first workpieces and with the second workpiece;

FIG. 14 is a side view of the tip prop of the ultrasonic welding system orientated over the first workpiece illustrated as an electrically insulated wire and the second workpiece illustrated as a electrically conductive terminal;

FIG. 15 is a side view of the tip prop orientated over the insulated wire with the terminal crimped to a surrounding insulation jacket of the wire;

FIG. 16 is a side view of the tip prop orientated over and pressing into the insulation jacket of the wire to form a sonic weld; and

FIG. 17 is a top view of a series of sonic welds placed in a series of respective wires and terminals.

### DESCRIPTION OF THE PREFERRED EMBODIMENTS

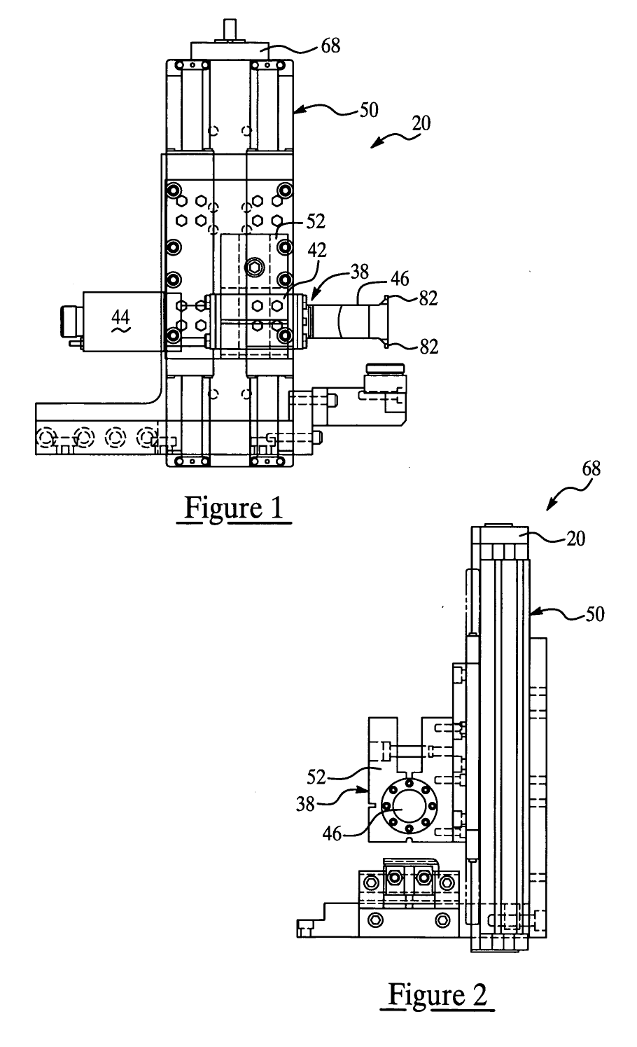

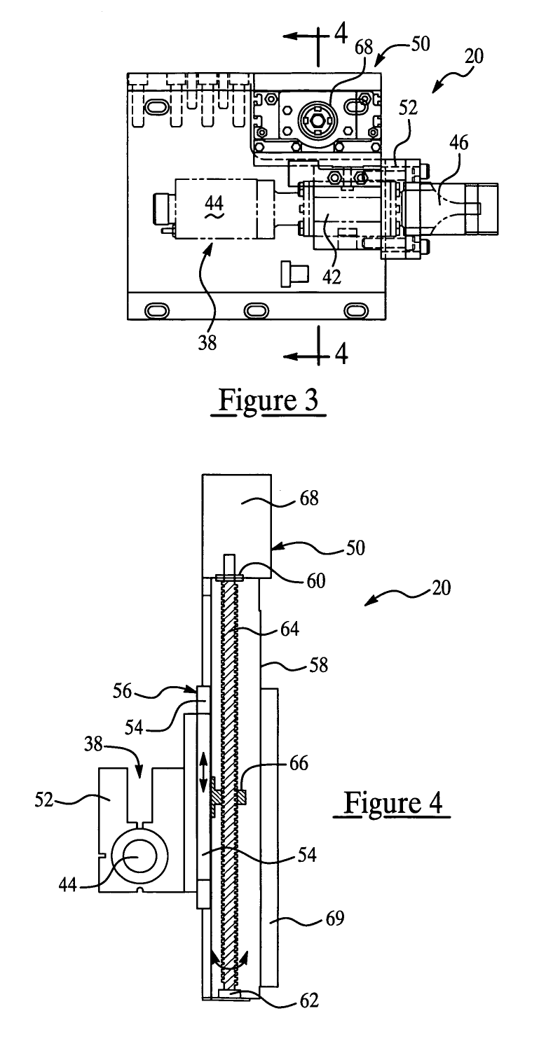

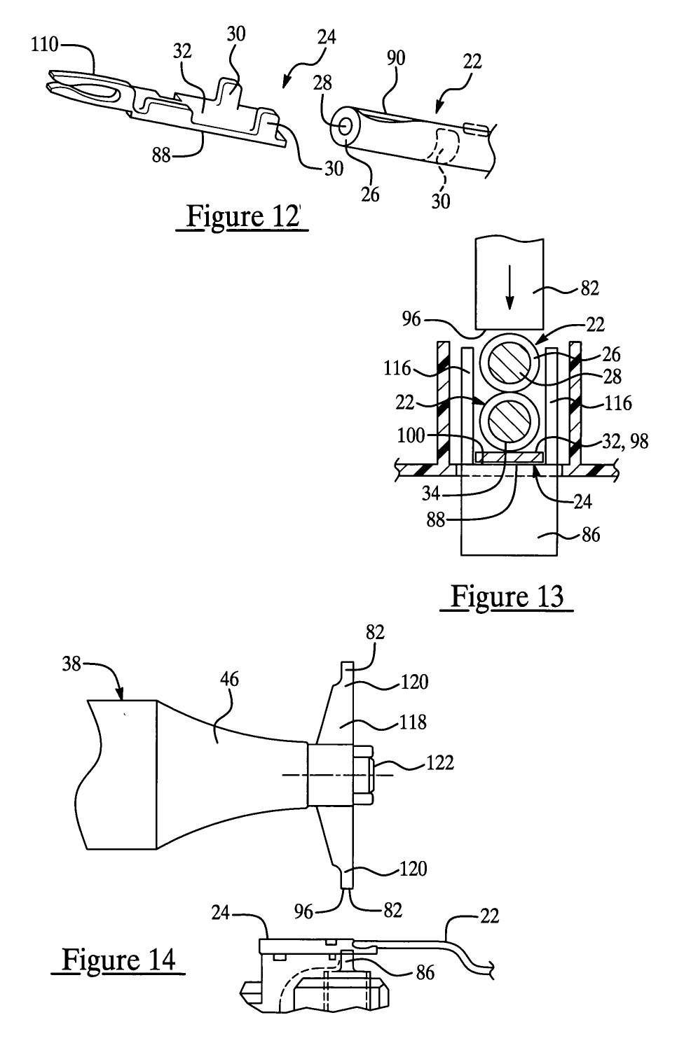

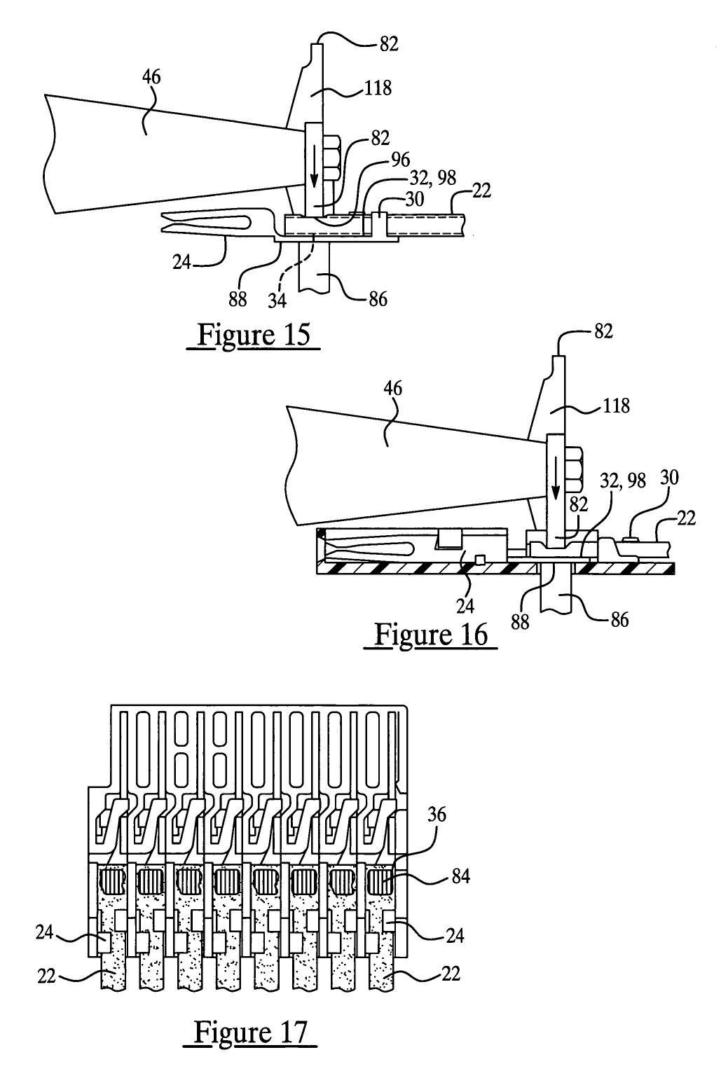

Referring to FIGS. 1-4 and 12-16 an ultrasonic welding system 20 of the present invention welds or galls a first workpiece 22 to a second workpiece 24 both being of generally like material. For the sake of example, and as illustrated as a preferred application but not limited to this application, the first and second workpieces 22, 24 are preferably made of substantially nonferrous metal. The first workpiece 22 as illustrated in FIG. 12 is preferably an electrically insulated wire having an outer electrically insulating jacket 26 and an inner electrically conductive core 28. The second workpiece 24 is preferably an electrical terminal that typically is first crimped to the insulation jacket 26 of the first workpiece 22 or insulated wire by a pair of terminal wings 30. In this example, contaminants which are generally polished away during the galling process are typically oxidation formed upon a contact surface 32 of the terminal 24, and the insulation jacket 26, itself, of the insulated wire 22. Upon completion of ultrasonic welding, the contact surface 32 of the terminal 24 is molecularly joined to a the contact surface 34 of the conductor core 28 of the insulated wire 22, and the insulation jacket 26 at the ultrasonic weld location is generally displaced as a displacement mass 36 (as best shown in FIG. 17). The terminal 24 and the wire 22 are thereby bonded together with a weld-like efficacy.

Preferably, an ultrasonic welder 38 of the ultrasonic welding system 20 is an “Ultraweld 40” ultrasonic welder of AMTECH (American Technology, Inc.) of Milford, Conn. This class of commercially available ultrasonic welders include: a solid state power supply that is user adjusted via a weld controller 40, a transducer 42 where electrical energy of the power supply is converted into mechanical vibration and an amplitude booster 44 where the mechanical vibrations of the transducer are amplified, and an output tool in the form of a horn 46 that tunes the vibrations to a tip 82 generally designed for a particular application. The ultrasonic welder 38 is combined or integrated with a servo press 50 to generally comprise the ultrasonic welding system 20.

A sub-frame 52 of the ultrasonic welder 38 supports the transducer, booster horn and tip and is preferably attached rigidly to a plate portion 54 of a moving shuttle 56 of the servo press 50. The shuttle 56 preferably moves substantially vertically with respect to a stationary and substantially vertical track or frame 58 which carries two journals 60, 62 for rotational support of a worm gear or male threaded ballscrew drive 64 linked to a female threaded portion 66 of the shuttle 56 and mechanically attached to the servo motor 68 for rotation (as best shown in FIG. 4). The track or frame 58 also supports at least one position sensor 69 for tracking of the shuttle position 56 and thus tip position with respect to the wire 22 and terminal 24.

A number of factors collectively determine the efficacy of the ultrasonic metal-to-metal surface bond, the major considerations being the amplitude of the vibration, the applied force and the time of application. The applied power (P) is defined by the amplitude (X) of vibration times the force (F) applied normal to the metal surfaces (P=FX), and the applied energy (E) is defined by the applied power (P) times the time (T) of application (E=PT). These variables are predetermined to achieve the most efficacious bond based upon the metals of the conductor core 28 of the wire 22 and terminal 24.

Prior to operation of the ultrasonic welding system 20, these operating values (i.e. amplitude, force and energy) must be entered into a logic controller 70 or the weld controller 40. The values are pre-established from empirical data previously taken which are further dependent upon many factors. These factors include but are not limited to: wire or core 28 gauge thickness, insulation jacket 26 thickness, terminal thickness 24, and the types of material applied. Other parameters controlled or monitored via the weld controller 40 include energy 72, force 74 or trigger pressure used during pre-height measurement 78, pressure 76, amplitude 80, time 81, power 83 and final height 85. Preferably, the operator enters energy 72 as opposed to time 81 or height 85 because empirical data has shown that better control of final product quality is achieved. Welding to height or time is less sensitive to the condition of the terminal 24 and insulated wire 22. For instance, a wire 22 with a missing strand of the conductive core 28 welded to a given height 85 does not provide the same weld quality as when all strands are present.

Trigger pressure 76 is used to compact the wire 22 on the terminal 24 for the purpose of measuring the pre-height 78 before welding for monitoring purposes. If this height does not fit a pre-established height range, a warning indication assumes, for example, that the wrong size wire 22 is being used, the wire is missing, or the terminal 24 is mis-positioned, and thus provides a warning indication. The trigger pressure should be set within about ten pounds per square inch of the final weld pressure. If the pre-height is within the pre-established range the ultrasonic welding system 20 will begin the weld process. For a typical weld, the process will take about 0.5 seconds for the illustrated example.

In regards to weld pressure, the actual pressure required to produce a good weld is derived in conjunction with inputted energy 72 and amplitude 80. The pressure that is ultimately set on the weld controller 40 is applied to the servo press 50 of the system 20 that will provide the clamping force of a welding tip 82 generally engaged to a distal end of the horn 46 on the wire 22 and terminal 24 combination. Knowing the torque applied by the electric servo motor 68 of the press 50 that exerts force between the tip 82 and an area 84 to be ultrasonically welded, and by calculation, a pound per square inch force on the actual welded area 84 can be calculated.

The amplitude 80 is preferably read in microns and moves generally co-planar to the terminal 24 and wire 22. Electrical energy is applied to the transducer or converter 42 of the welder 38 where a crystal like material is excited at its natural frequency. A typical frequency is about forty kilohertz. The minute vibrations are transferred through the acoustically designed tuned booster 44 and transferred along to the horn 46. The greater the voltage applied to the converter, the greater the amplitude.

During operation of the ultrasonic welding system 20, the wire 22 and the terminal 24, which is pre-crimped to the insulation jacket 26, are together placed between the tip 82 and a generally stationary anvil 86 of the ultrasonic welding system 20. The tip 82 projects and presses generally downward upon the insulating jacket 26 of the wire 22. The anvil 86 of the ultrasonic welding system 20 projects upward to directly contact a substantially planar bottom surface 88 of the terminal 24.

Referring to FIG. 12, in preparation for welding, the insulation jacket 26 at the weld area 84 of the wire 22 need not be stripped, but preferably has an imprint or longitudinal slit 90 to assist in the welding process. Because of the unique design of the anvil 86 and the tip 82 used with the welder 38, the electrical conductor 28 of the wire 22 is not limited to a solid core or single strand, but can be utilized with multi-stranded conductor cores or copper material. The insulating jacket 26 which covers the conductor core 28 is of a meltable material such as thermoplastic, and preferably polyvinyl chloride or polyester. The terminal 24 is nonferrous and preferably of a metal substantially softer than the steel of the tip 82 and anvil 86.

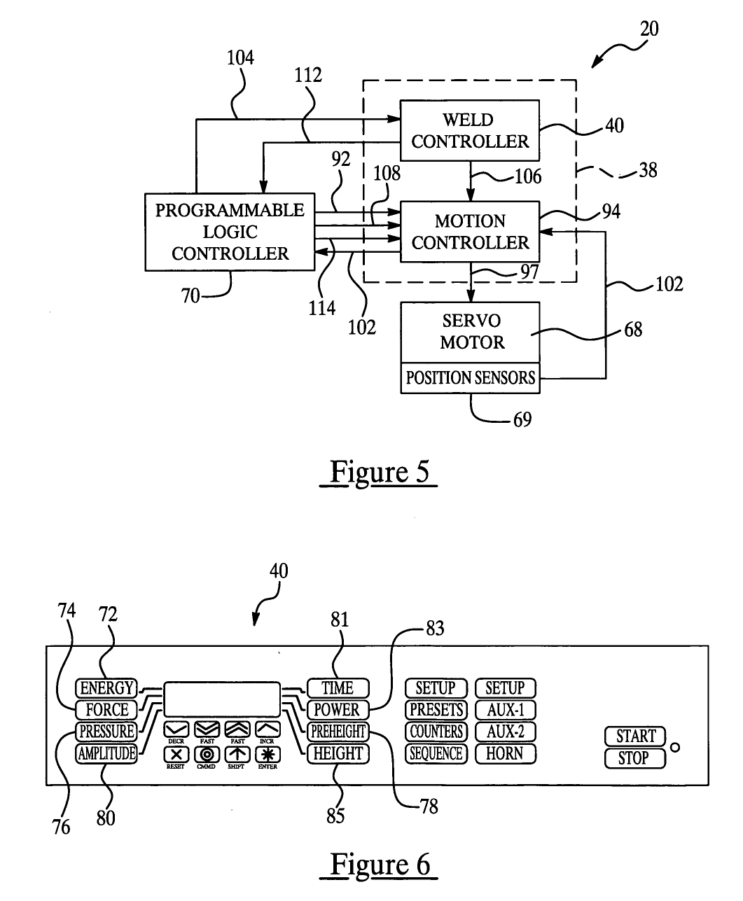

Referring to FIGS. 5-8, during operation of the ultrasonic welding system 20, the programmable logic controller 70 outputs an initiation and high speed signal 92 to a motion controller 94 of the ultrasonic welder 38 that delivers a torque limiting signal 97 to the servo motor 68. The motor 68 rotates the drive 64 which lowers the shuttle 56 and thus the tip 82 toward the anvil 86 and against the insulating jacket 26 of the wire 22 at a relatively high rate of speed. Once a work surface 96 of the tip 82 is initially moved into forceful abutment with the insulation jacket 26 of the wire 22, wherein the insulation jacketed wire is sandwiched against a top surface 98 of the terminal 24 and the bottom surface 88 of the terminal 24 is abutted against a work surface 100 of the anvil 86 (as best shown in FIGS. 9-11). The pre-slit insulation jacket 26 is further dimpled or deformed by the substantially smooth work surface 96 of the tip 82, but not necessarily broken. At this stage of operation, the logic or weld controllers 70, 40 determines via the motion controller 94 which receives position signals 102 from the position sensors 69 of the servo press 50 whether surfaces are located within a predetermined allowance, statistically pre-established. If not, an error is called out, otherwise the microprocessor programming advances to the actual sonic welding process.

The logic controller 70 outputs a weld initiation signal 104 to the weld controller 40 which sends an analog signal 106 of pre-weld and weld forces to the motion controller 94. Generally simultaneously, the logic controller 70 outputs a slow speed signal 108 to the motion controller 94 and the solid state power supply activates the transducer/booster, whereupon mechanical vibration arrives via the horn 46 to the slowly downward moving tip 82. The insulation jacket 26 thus vibrates with the work surface 96 of the tip 82 relative to the wire 22. With continued vibration, the insulation jacket 26 heats and melts, thus flowing away from the area 84 directly between the work surface 96 of the tip 82 and the top surface 98 of the terminal 24 as the tip vibrates and continues to be forced toward the anvil 86, as best shown in FIGS. 13-16.

Although the tip 82 and the anvil 86 have mutually facing or confronting work surfaces, only the anvil work surface 100 is preferably knurled to grip the bottom surface 88 of the terminal 24 as the tip 82 is forced toward the anvil 86. The tip work surface 96 is substantially smooth to reduce the time necessary to displace the insulation jacket 26. The frequency may be fixed at twenty kHz, at forty kHz or at another frequency, or the frequency may be other than fixed. In any event, the pre-established frequency shall be such that a resonance frequency is not produced within the terminal 24 which could potentially damage or crack portions of the terminal including the tuning-fork shaped prongs 110.

Referring to FIG. 5, upon conclusion of the ultrasonic welding process, the weld controller 40 outputs a weld complete signal 112 to the logic controller 70 that then outputs a raise press signal 114 to the motion controller 94. With completion of the weld, the insulation jacket 26 has formed the displacement mass 36 on generally diametrically opposing sides of the ultrasonic weld 84 where the tip 82 was located. At the weld 84, the copper conductor 28 of the wire 22 is exposed at one side and bonded by the ultrasonic weld 84 to the top surface 98 of the terminal 24.

Referring to FIG. 13, the ultrasonic welding system 20 is capable of welding more than one first workpieces or wires 22 to the single second workpiece 24 or terminal. As illustrated, two or more wires 22, preferably having ultra thin wall polyvinyl chloride insulation jackets 26, can be ultrasonic welded to one-another and to the terminal. The wires 22 are preferably gathered together via a pair of ears 116 of the anvil 86 disposed substantially parallel to each other. Because the terminal 24 extends between the ears 116, the ears are spaced apart from one another at a distance slightly greater than the width of the terminal. To enable a multi-wire weld, the width of the tip 82 is almost as great as the distance between the two ears 116. The idea being, any distance between the tip 82 and the ears 116 is smaller than the diameter of a single strand of wire conductor 28. This assures every strand remains under the tip 82 and thus exposed to the welding process. That is, all the strands of copper are captured under the welding tip 82 and are not able to move laterally away from the weld area 84.

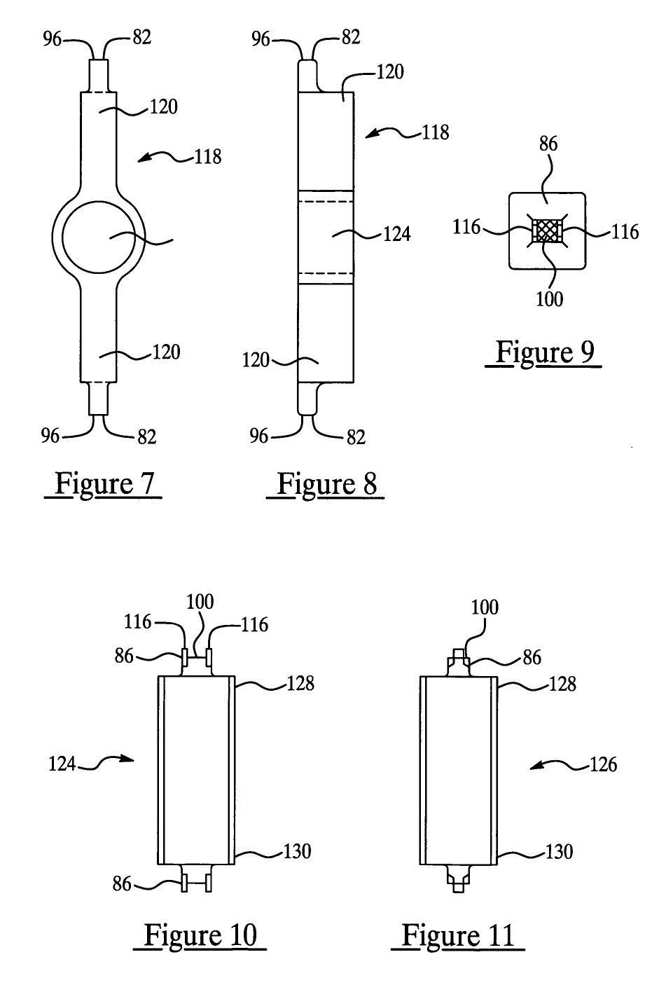

As best illustrated in FIGS. 7-14, an elongated linear prop 118 is preferably unitary to the horn 46 and carries two diametrically opposing tips 82 at respective ends 120. The unitary construction of the prop 118 and horn 46 is preferred for consistent control of the energy and amplitude through the horn 46 to the weld. As an alternative, the prop 118 can be engaged to the end of the horn via a threaded nut 122 (see FIG. 14) that engages a threaded portion of the horn that extends through a mid-point hole 124 carried by the prop 118. The prop 118 is thus disposed concentrically to the horn 46 and both as a single part are capable of rotating one hundred and eighty degrees to utilize the second tip 82 when the first tip 82 wears out or becomes damaged. Having two tips 82 on each prop 118 reduces the cost of manufacturing the tip 82 and simplifies maintenance of the ultrasonic welder 38. The tips 82 are preferably made of a hardened steel which is coated with titanium nitride for wear. Other hard coat materials such as chromium nitrite are also acceptable. The tips 82 are further void of any sharp edges which could damage or cut through the wire 22 prior to achieving an ultrasonic weld 84. As previously described, the tip work surface 96 is smooth and thus provides a quicker weld as opposed to neural patterns on the tip. Moreover, the smooth tip 82 requires less machining to produce the tip tool or prop 118. In order to ensure bonding of all the strands of the conductor 28 of the wire 22, the tip work surface 96 must be substantially parallel to the top surface 98 of the terminal 24 (i.e. as oppose to a concave geometry). A parallel geometry provides a uniform pressure or force across the weld, thereby bonding all the conductor strands 28.

Referring to FIGS. 9-11, the anvil 86 is carried preferably by an elongated linear anvil prop 126. Like the tips 82, anvils 86 are preferably carried on each diametrically opposed ends 128, 130 of the anvil prop 126. Each anvil 86 supports the ears 116 as previously described. The ears 116 are preferably constructed and arranged to be detachable from the anvils 86. With this configuration, in the event that one or both of the ears 116 should break, replacement or maintenance is limited to the ears 116 and not the whole anvil and prop 124. The ears 116 are held to the anvil 86 by a dowel or pin (not shown). The anvil 86 is made of hardened steel for purposes of wear. Because the ears 116 are exposed to lateral forces or shear stresses, the ear material is not as brittle as the anvil material, and although hardened the ear steel is softer than the anvil material. Moreover, the ears 116 are not exposed, and need not withstand the wear, of the anvil 86; therefore, the ears 116 need not be as hard.

The methodology according to the present invention has great utility for the handling of small gauge wires 22, ranging at about twenty-six gauge. Small gauge wires are frequently very difficult to strip without injuring the wire 22. This is especially true for wires having a stranded conductor or core 28. Consequently, ultrasonic welding of high gauge or small wires is costly and difficult. However, the method according to the present invention does not require pre-stripping of wires, so that now small diameter wires, including thin and ultra-thin wires ranging in insulator thickness from 0.4 to 0.2 millimeters, can be economically attached to the terminals 24.

Moreover, the utilization of ultrasonic welding technology allows for the assembly of wire harnesses having wire diameters smaller than twenty-two gauge and ranging at about twenty-six gauge. This results in reduced wire harness bundle size, reduced mass, reduced cost, and further eliminates wire stripping and the potential of strand breakage or cuts that stripping produces. Also, connection to ultra-thin wall wire or cable is now possible.

The welder 38 has a series of quality control features which monitor the welding process. These monitoring features are generally adjustable, thus capable of controlling the number of rejected or non-conforming parts. The first monitoring feature is a time feature which monitors the actual time that ultrasonic energy is running. The feature time is not the full cycle time but is the actual weld time. This time is a good indication of the nonferrous material quality and cleanliness. If the weld time exceeds a pre-established duration, it is a likely indication that contaminates exists. Oxides, or other contaminants are inherently slippery and do not allow the proper metal-to-metal friction necessary to produce the weld 84.

A second quality control feature is that of power which is similar to time because work done on the weld 84 is equal to power times time. Therefore, a weld that draws minimal power binds nonferrous metals that are more likely to contain higher levels of contaminants.

Aside from the pre-height feature 78 previously discussed, a final height quality control feature measures the final height 85 of the weld 84. Under typical welding scenario for a single wire 22, the variation in the final height 85 should be about 0.1 millimeters. If the final weld height 85 falls above this range, it is a warning indication of under welding most likely due to excess contamination. If the final weld height falls under this range, it is a warning indication that wire strands 28 have escaped or have not been captured within the weld area 84 and thus not included in the height reading.

While the forms of the invention herein disclosed constitute presently preferred embodiments, many others are possible. For instance, the ultrasonic welding system can be utilized for other applications such as bonding plastic parts such as fasteners together, or bonding various fabrics to name but a few applications. It is not limited herein to mention all the possible equivalent forms or ramifications of the invention. It is understood that the terms used herein are merely descriptive rather than limiting and that various changes may be made without departing from the spirit or scope of the invention.

1. An ultrasonic welding system for galling a first workpiece directly to a second workpiece, the ultrasonic welding system comprising:
a tip being in direct contact with the first workpiece;
an anvil being in direct contact with the second workpiece and spaced controllably away from the tip with the first and second workpieces located between the tip and the anvil;
a transducer for converting electrical energy into mechanical vibration transmitted to the tip; and
a press device having a servo motor for transporting and positioning the tip with respect to the anvil.

2. The ultrasonic welding system set forth in claim 1 further comprising a motion controller for adjusting the approach velocity of the tip with respect to the anvil.

3. The ultrasonic welding system set forth in claim 2 further comprising an amplitude booster for amplifying the mechanical vibration produced by the transducer and being connected to the positioning device.

4. The ultrasonic welding system set forth in claim 1 wherein the first and second workpieces are, at least in part, nonferrous metal.

5. The ultrasonic welding system set forth in claim 4 wherein the first workpiece is an electrical wire having a non-stripped electrically insulating jacket and an inner electrically conductive core.

6. The ultrasonic welding system set forth in claim 5 wherein the second workpiece is an electrical terminal.

7. The ultrasonic welding system set forth in claim 6 wherein the tip and anvil are constructed and arranged to compress the wire directly to the terminal while galling the conductive core of the wire to the terminal.

8. The ultrasonic welding system set forth in claim 1 wherein the first workpiece is an electrical wire having an inner conductive core and a surrounding insulation jacket, and wherein the terminal and the tip are in compressive direct contact with the insulation jacket and the insulation jacket flows away from the conductive core of the wire to form a displacement mass during the ultrasonic welding.

9. The ultrasonic welding system set forth in claim 8 further comprising:
the anvil having an upward facing work surface directly contacting a bottom surface of the terminal; and
a pair of ears projecting between the tip and the anvil, wherein the work surface is disposed substantially between the pair of ears to trap the conductive core between the tip and the terminal during ultrasonic welding.

10. The ultrasonic welding system set forth in claim 8 further comprising:
the anvil having an upward facing work surface directly contacting a bottom surface of the terminal; and
the tip having a downward facing work surface directly contacting the insulation jacket of the wire during initiation of ultrasonic welding.

11. The ultrasonic welding system set forth in claim 10 wherein the work surface of the tip is smooth.

12. The ultrasonic welding system set forth in claim 11 wherein the work surface of the anvil is knurled.

13. The ultrasonic welding system set forth in claim 8 further comprising:
a prop engaged to and for supporting the anvil; and
a pair of ears engaged to the prop and extending upward beyond on both sides of the terminal for trapping the electrical wire laterally during the weld process.

14. The ultrasonic welding system set forth in claim 13 wherein the tip and the anvil are made of hardened steel.

15. The ultrasonic welding system set forth in claim 14 wherein the anvil and the tip are coated with titanium nitride.

16. The ultrasonic welding system set forth in claim 5 wherein the electrical wire is between the range of thirty and eighteen gage.

17. The ultrasonic welding system set forth in claim 2 further comprising a weld controller for reporting an analog signal indicating a desired pre-weld and weld force to the motion controller for translation into a motor torque signal by the motion controller.

18. The ultrasonic welding system set forth in claim 17 further comprising at least one servo position sensor for sending an electric position signal of the tip to the motion controller.

19. The ultrasonic welding system set forth in claim 18 further comprising a programmable logic controller which receives the position signal from the motion controller and a weld complete signal from the weld controller and outputs a weld initiation signal to the weld controller, an initiation and high speed signal to the motion controller, a low speed signal to the motion controller, and a raise press signal to the motion controller.

20. An ultrasonic welding system for galling a first electrical conductor directly to a second electrical conductor, the ultrasonic welding system comprising:
a tip being in direct contact with the first electrical conductor;
an anvil being in direct contact with the second electrical conductor and spaced controllably away from the tip with the first and second electrical conductors located between the tip and the anvil;
a transducer for converting electrical energy into mechanical vibration transmitted to the tip; and
a press device having:
a servo motor for transporting and positioning the tip with respect to the anvil,
an elongated rotating drive shaft linked rotatably to the servo motor, and
a shuttle coupled to the drive shaft and engaged to the tip and the transducer, wherein the shuttle is constructed and arranged to ride along the length of the drive shaft as the drive shaft rotates.

21. The ultrasonic welding system set forth in claim 20 further comprising a programmable logic controller for electrically controlling the servo motor.
